(19) United States
(12) Patent Application Publication
(10) Pub. No.: US 2019/0166642 A1
(43) Pub. Date: May 30, 2019

(54) RADIO COMMUNICATION SYSTEM

(71) Applicant: NTT DOCOMO, INC., Tokyo (JP)

(72) Inventors: Shinya Takeda, Tokyo (JP); Wuri Andarmawanti Hapsari, Tokyo (JP); Shin-Ichi Isobe, Tokyo (JP); Motohiro Abe, Tokyo (JP)

(73) Assignee: NTT DOCOMO, INC., Tokyo (JP)

(21) Appl. No.: 16/302,289

(22) PCT Filed: Apr. 26, 2017
(86) PCT No.: PCT/JP2017/016618

§ 371 Date: Nov. 16, 2018

(30) Foreign Application Priority Data
Jul. 8, 2016 (JP) 2016-136421

(51) Int. Cl. H04W 76/15; H04W 48/18; H04W 60/04; H04W 60/02; H04W 64/00

(52) U.S. Cl. CPC H04W 76/15; H04W 48/18; H04W 88/06; H04W 60/02; H04W 64/003; H04W 60/04

(57) ABSTRACT

A radio communication system that includes a user equipment; a base station; a first management apparatus that manages the user equipment according to a first RAT; and a second management apparatus that manages the user equipment according to a second RAT is disclosed. The base station includes a controller that controls radio communication with the user equipment and a transmitter that transmits first location registration information of the first management apparatus and second location registration information of the second management apparatus. The user equipment includes a receiver that receives the first location registration information and the second location registration information from the base station, a manager that retains location registration information, and a processor that determines the location registration in the first or second management apparatus is necessary and that performs the location registration in accordance with the determination.

### TECHNICAL FIELD

The present invention relates to a radio communication system.

### BACKGROUND ART

At present, as a next generation radio communication system of Long Term Evolution (LTE) systems and LTE-Advanced systems, the specifications of the 5th generation (5G) system have been developed to achieve higher capacity for supporting increasing traffic and to achieve effective support for Internet of Things (IoT) terminals. Specifically, in 5G systems, ultra high-speed data rate communication exceeding 10 Gbps is attempted to be achieved and cost reduction and power consumption reduction are attempted to be achieved for user equipment (UE), such as an IoT terminal.

In LTE systems, user equipment residing in an LTE area implements radio communication via a base station (evolved NodeB: eNB) and a core network (CN), which conform to the LTE standard. Specifically, as illustrated in FIG. 1, user equipment accesses an LTE radio access network (RAN) base station through radio and accesses an LTE system via the LTE RAN base station under management of LTE CN (for example, a mobility management entity (MME), a P-GW (packet data network (PDN) gateway), a serving-gateway (S-GW), etc.). In this case, the user equipment communicates signals with the LTE RAN base station according to access stratum (AS) protocols conforming to the LTE standard and communicates signals with LTE CN according to non access stratum (NAS) protocols.

In general, in a radio communication system, user equipment performs location registration in a network so that the network can ascertain the positions of the user equipment, and the network can make a terminating call to the user equipment based on registered positional information. In a location registration process in an LTE system, as illustrated in FIG. 2, suppose that a user equipment UE1 that originally performs location registration to the LTE CN in a Tracking Area Code (TAC) 1 moves to an area of an LTE CN in TAC 2. Here, the TAC is a code indicating a location registration area according to the LTE standard. Upon detecting that the location registration area is changed based on system information broadcasted from a base station of LTE CN of TAC 2, the user equipment UE1 performs location registration in LTE CN of TAC 2. Thus, a network can ascertain the position of the user equipment UE1 and can transmit a terminating call to an appropriate location registration area.

### PRIOR ART DOCUMENT

### Non-Patent Document

Non-Patent Document 1: 3GPP TR23.799 V0.5.0 (2016-05)

### SUMMARY OF THE INVENTION

### Problem to be Solved by the Invention

However, in an environment in which architectures including core networks using different radio access technologies (RATs) such as LTE and 5G coexist, a scheme for performing location registration in a core network corresponding to an appropriate timing has not been considered.

In view of the above-described problem, an object of the invention is to provide a technology for achieving location registration of a user equipment in an environment in which core networks using different RATs coexist.

### Means for Solving the Problem

To achieve the foregoing object, according to an aspect of the invention, a radio communication system includes: a user equipment; a base station configured to perform radio communication with the user equipment; a first management apparatus configured to be communicatively connected to the base station and manage the user equipment according to a first radio access technology (RAT); and a second management apparatus configured to be communicatively connected to the base station and manage the user equipment according to a second RAT different from the first RAT. The base station includes a communication control unit that controls radio communication with the user equipment and a location registration information transmission unit that transmits first location registration information of the first management apparatus and second location registration information of the second management apparatus. The user equipment includes a location registration information acquisition unit that acquires the first location registration information and the second location registration information from the base station, a location registration information management unit that retains location registration information, a location registration necessity determination unit that determines that location registration in the first or second management apparatus is necessary based on the retained location registration information and the location registration information corresponding to the management apparatus managing the user equipment between the acquired first location registration information and second location registration information, and a location registration processing unit that performs location registration in the first or second management apparatus when it is determined that the location registration in the first or second management apparatus is necessary.

### Advantage of the Invention

According to the invention, location registration of user equipment can be performed in an environment in which core networks using different RATs coexist.

### BRIEF DESCRIPTION OF DRAWINGS

FIG. 1 is a schematic diagram illustrating an LTE architecture example;

FIG. 2 is a schematic diagram illustrating a location registration process in an LTE system;

FIG. 3 is a schematic diagram illustrating a 5G architecture example;

FIG. 4 is a schematic diagram illustrating location registration in a 5G system;

FIG. 5 is a schematic diagram illustrating a radio communication system according to an embodiment of the invention;

FIG. 6 is a block diagram illustrating a functional configuration of a base station according to an embodiment of the invention;

FIG. 7 is a block diagram illustrating a functional configuration of a user equipment according to an embodiment of the invention;

FIG. 8 is a schematic diagram illustrating a location registration process according to an embodiment of the invention;

FIG. 9 is a flowchart illustrating a location registration process by a user equipment according to an embodiment of the invention;

FIG. 10 is a schematic diagram illustrating another 5G architecture example;

FIG. 11 is a schematic diagram illustrating location registration in a 5G system;

FIG. 12 is a schematic diagram illustrating a location registration process according to an embodiment of the invention;

FIG. 13 is a flowchart illustrating a location registration process by a user equipment according to an embodiment of the invention;

FIG. 14 is a schematic diagram illustrating location registration in a 5G system;

FIG. 15 is a schematic diagram illustrating a location registration process according to an embodiment of the invention;

FIG. 16 is a flowchart illustrating a location registration process by a user equipment according to an embodiment of the invention;

FIG. 17 is a schematic diagram illustrating a location registration process according to an embodiment of the invention; and

FIG. 18 is a block diagram illustrating a hardware configuration of a user equipment, a base station, and a management apparatus according to an embodiment of the invention.

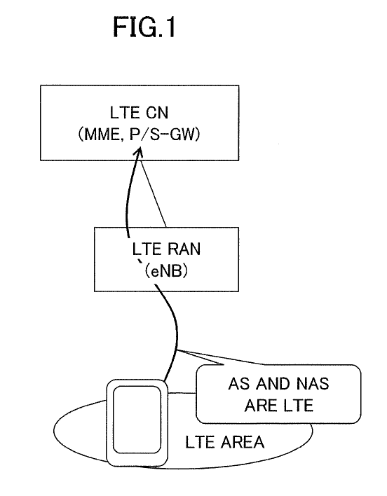

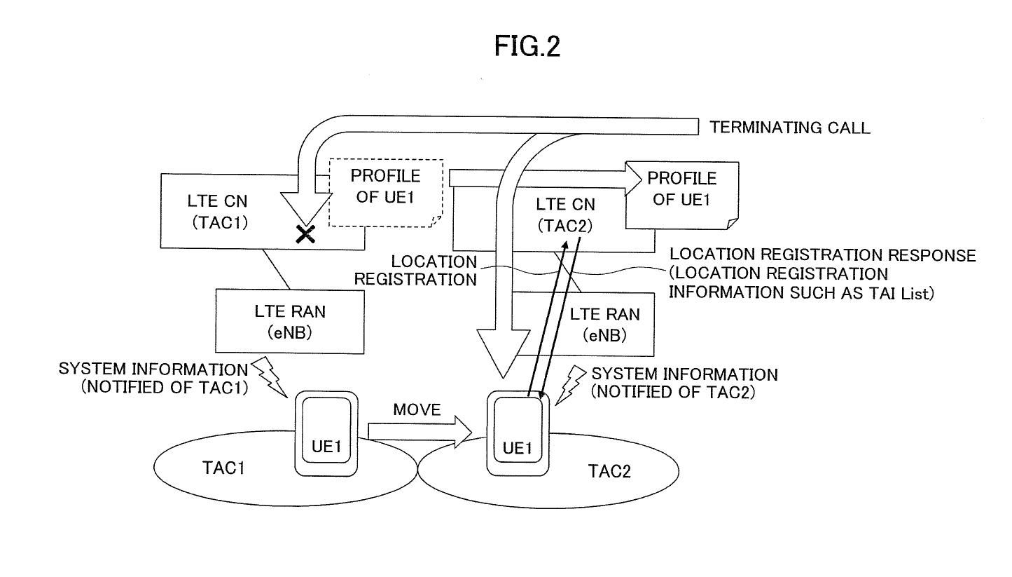

### EMBODIMENTS OF THE INVENTION

Hereinafter, embodiments of the invention are described with reference to the drawings.

In the following embodiments, a radio communication system is disclosed, which is for implementing appropriate location registration in an environment in which architectures including core networks using different radio access technologies (RATs) such as LTE and 5G coexist. In summary, in embodiments described below, a base station notifies of both pieces of location registration information (for example, TAC) of core networks to which different RATs are applied. A user equipment compares location registration information retained in the core network managed by the user equipment to the location registration information of the corresponding core network acquired from the base station. When the pieces of location registration information do not match each other, the user equipment performs location registration in the core network.

Thus, in an environment in which core networks to which different RATs are applied coexist, a user equipment can perform location registration in the core network of the RAT for managing the user equipment at an appropriate timing such as a time point at which the location registration is performed in the core network that has different location registration areas because of movement.

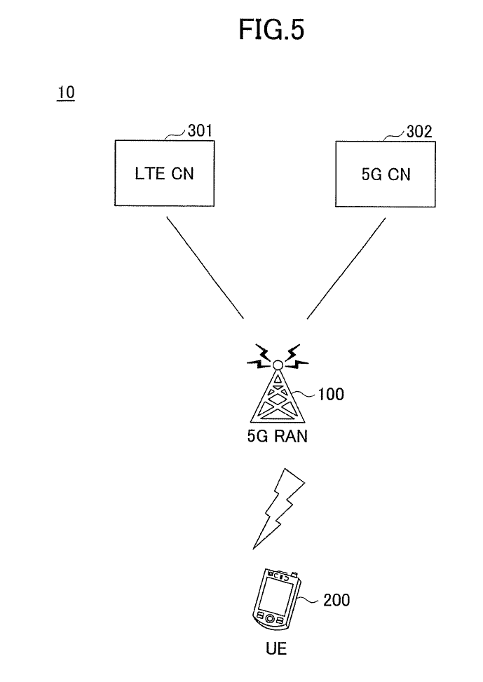

First, a radio communication system according to an embodiment of the invention is described with reference to FIG. 5. FIG. 5 is a schematic diagram illustrating the configuration of the radio communication system according to the embodiment of the invention.

As illustrated in FIG. 5, a radio communication system 10 includes a base station 100, a user equipment 200, an LTE core network 301, and a 5G core network 302 (hereinafter which may be referred to as core networks 300).

The radio communication system 10 is typically a radio communication system that conforms to two or more radio access technologies (RATs) in accordance with 3rd Generation Partnership Project (3GPP) standards of LTE systems, LTE-Advanced systems, 5G systems, or the like, but the invention is not limited thereto. The radio communication system 10 may be a radio communication system that conforms to an RAT in accordance with a non-3GPP standard such as Wi-Fi wireless local area network (LAN). In the embodiments illustrated in the drawings, only one base station 100 is illustrated. However, typically, numerous base stations 100 are disposed to cover a service area of the radio communication system 10. Similarly, numerous core networks 300 are disposed to cover the service area of the radio communication system 10.

The base station 100 is wirelessly connected to a user equipment 200 via a cell, and thus transmits a downlink (DL) packet received from a higher station or a server communicatively connected to a core network 300 to the user equipment 200 and transmits an uplink (UL) packet received from the user equipment 200 to the higher station or the server. In the following embodiments, the base station 100 performs radio control according to a 5G standard, but the invention is not limited thereto. The base station 100 may conform to any standard such as a 3GPP standard or a non-3GPP standard.

The user equipment (UE) 200 transmits and receives radio signals to and from the base station 100 via a 5G cell provided by the base station 100 under management of the LTE core network 301 and/or the 5G core network 302. Specifically, the user equipment 200 interchanges signals with the base station 100 according to an AS protocol and interchanges signals with the LTE core network 301 and the 5G core network 302 according to an NAS protocol. Typically, the user equipment 200 may be any appropriate information processing apparatus that has a radio communication function of a smartphone, a mobile phone, a tablet, a mobile router, a wearable terminal, an IoT terminal, or the like.

The LTE core network 301 is a management apparatus that manages the user equipment 200 according to an LTE standard or an LTE-Advanced standard. The LTE core network 301 performs call control, location registration, user authentication, and a connection process and a communication process for connection to an external network such as the Internet on the user equipment 200 via the base station 100 according to an LTE standard or an LTE-Advanced standard.

The 5G core network 302 is a management apparatus that manages the user equipment 200 according to a 5G standard. The 5G core network 302 performs call control, location registration, user authentication, and a connection process and a communication process for connection to an external network such as the Internet on the user equipment 200 via the base station 100 according to a 5G standard.

In typical location registration, when the user equipment 200 is attached or resides in a cell provided by the base station 100, the LTE core network 301 and/or the 5G core network 302 interchange a message with the user equipment 200 via the base station 100 according to the NAS protocol, and thus performs location registration of the user equipment 200 and notifies the user equipment 200 of self-location registration information (for example, TAC). When the user equipment 200 receives the location registration information, the user equipment 200 retains the received location registration information. Thereafter, with movement (handover or the like) of the user equipment 200 between the base stations 100, the LTE core network 301 and/or the 5G core network 302 appropriately update the location registration of the user equipment 200. Typically, the LTE core network 301 and/or the 5G core network 302 include the plurality of subordinate base stations 100. Therefore, there are cases in which the movement of the user equipment 200 involves and does not involve updating of the location registration.

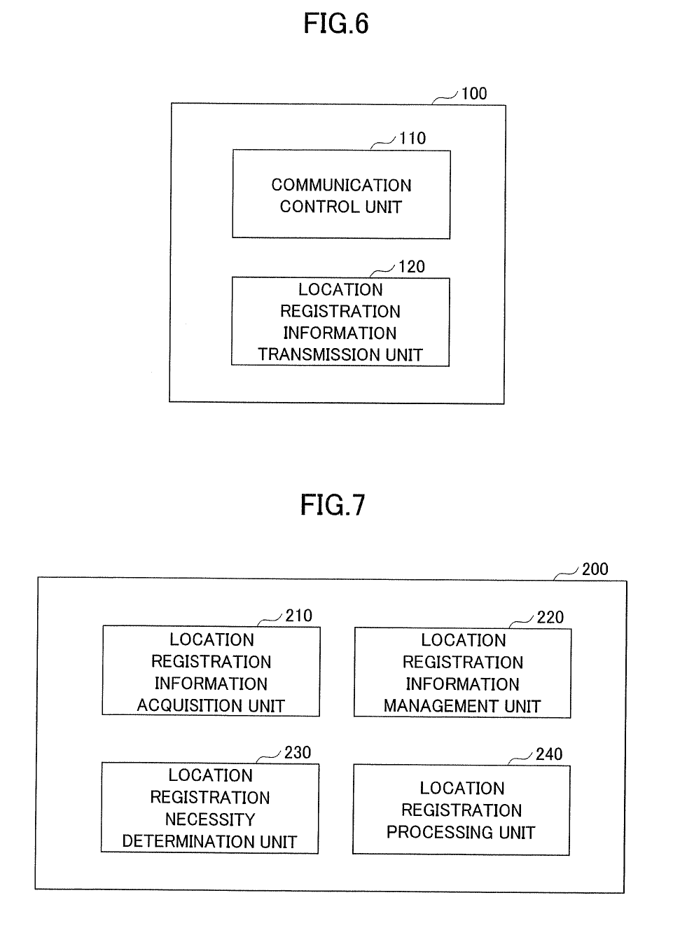

Next, a base station according to an embodiment of the invention is described with reference to FIG. 6. FIG. 6 is a block diagram illustrating a functional configuration of the base station according to the embodiment of the invention.

As illustrated in FIG. 6, the base station 100 includes a communication control unit 110 and a location registration information transmission unit 120.

The communication control unit 110 controls radio communication with the user equipment 200. Specifically, the communication control unit 110 transmits and receives various control signals and data signals to and from the user equipment 200 via one or more cells.

The location registration information transmission unit 120 transmits location registration information of the LTE core network 301 and location registration information of the 5G core network 302. That is, in the embodiment, the user equipment 200 is notified of both the location registration information of the LTE core network 301 and the location registration information of the 5G core network 302. Specifically, the location registration information transmission unit 120 may notify the user equipment 200 of the location registration information of the LTE core network 301 and the location registration information of the 5G core network 302 by broadcasting system information including TAC of each of the LTE core network 301 and the 5G core network 302 controlling the base station 100.

However, the location registration information is not limited to the TAC, but may be any appropriate identifier indicating a location registration area of the core networks 300 of a tracking area identity (TAI) list or the like including a plurality of TACs.

Next, the user equipment according to an embodiment of the invention is described with reference to FIG. 7. FIG. 7 is a block diagram illustrating a functional configuration of the user equipment according to the embodiment of the invention.

As illustrated in FIG. 7, the user equipment 200 includes a location registration information acquisition unit 210, a location registration information management unit 220, a location registration necessity determination unit 230, and a location registration processing unit 240.

The location registration information acquisition unit 210 acquires the location registration information of the LTE core network 301 and the location registration information of the 5G core network 302 from the base station 100. For example, when both of the location registration information of the LTE core network 301 and the location registration information of the 5G core network 302 are notified of in the system information broadcasted from the base station 100, the location registration information acquisition unit 210 may extract the location registration information of the LTE core network 301 and the location registration information of the 5G core network 302 from the received system information.

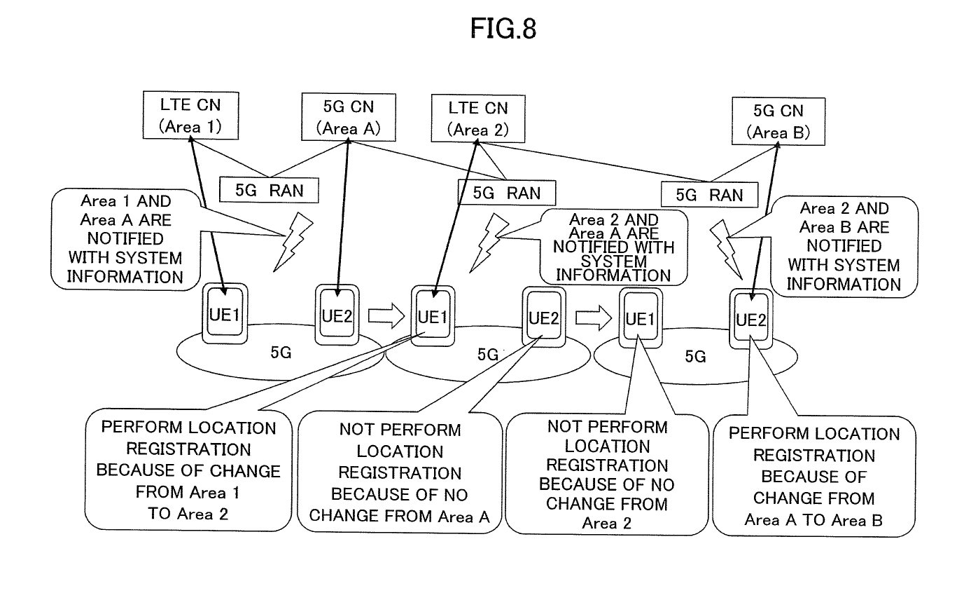

In a specific example illustrated in FIG. 8, UE1 and UE2 receive the system information including the pieces of location registration information of the LTE core network 301 and the 5G core network 302 from the base station 100 in a 5G cell in which UE1 and UE2 reside. For example, when UE1 and UE2 reside in the leftmost 5G cell, UE1 and UE2 receive Area 1 as the location registration information of the LTE core network 301 and receive Area A as the location registration information of the 5G core network 302 from the base station 100. When UE1 and UE2 reside in the middle 5G cell, UE1 and UE2 receive Area 2 as the location registration information of the LTE core network 301 and receive Area A as the location registration information of the 5G core network 302 from the base station 100. When UE1 and UE2 reside in the rightmost 5G cell, UE and UE2 receive Area 2 as the location registration information of the LTE core network 301 and receive Area B as the location registration information of the 5G core network 302 from the base station 100. The location registration information acquisition unit 210 supplies the pieces of acquired location registration information of the LTE core network 301 and the 5G core network 302 to the location registration necessity determination unit 230.

The location registration information management unit 220 retains the location registration information. Specifically, the location registration information management unit 220 retain the location registration information of the LTE core network 301 and/or the 5G core network 302 for which the user equipment 200 successfully performs the location registration. In the specific example illustrated in FIG. 8, when UE1 and UE2 are attached to the leftmost 5G cell, UE1 retains Area 1 as the location registration information of the LTE core network 301 and UE2 retains Area A as the location registration information of the 5G core network 302.

The location registration necessity determination unit 230 determines whether the location registration in the LTE core network 301 or the 5G core network 302 is necessary based on the location registration information corresponding to the LTE core network 301 or the 5G core network 302 managing the user equipment 200 and the location registration information retained in the location registration information management unit 220 among the pieces of acquired location registration information of the LTE core network 301 and the 5G core network 302.

For example, when the user equipment 200 is managed by the LTE core network 301, the location registration necessity determination unit 230 determines whether the location registration in the LTE core network 301 is necessary by determining whether the location registration information of the LTE core network 301 retained by the location registration information management unit 220 matches the location registration information of the LTE core network 301 acquired by the location registration information acquisition unit 210. When the user equipment 200 is managed by the 5G core network 302, the location registration necessity determination unit 230 determines whether the location registration in the 5G core network 302 is necessary by determining whether the location registration information of the 5G core network 302 retained by the location registration information management unit 220 matches the location registration information of the 5G core network 302 acquired by the location registration information acquisition unit 210.

Specifically, when the user equipment 200 is managed by the LTE core network 301, the location registration necessity determination unit 230 determines whether the location registration information of the LTE core network 301 retained by the location registration information management unit 220 matches the location registration information of the LTE core network 301 acquired by the location registration information acquisition unit 210. When the retained location registration information does not match the acquired location registration information, the location registration necessity determination unit 230 determines that the location registration in the LTE core network 301 is necessary and instructs the location registration processing unit 240 to perform the location registration in the LTE core network 301. Conversely, when the retained location registration information matches the acquired location registration information, the location registration necessity determination unit 230 determines that the location registration in the LTE core network 301 is unnecessary.

In the specific example illustrated in FIG. 8, when UE1 is managed by the LTE core network 301 and UE1 moves from the leftmost 5G cell to the middle 5G cell, the location registration information Area 1 retained by UE1 does not match the acquired location registration information Area 2, and thus UE1 determines that the location registration in the LTE core network 301 of Area 2 is necessary. Conversely, when UE1 moves from the middle 5G cell to the rightmost 5G cell, the location registration information Area 2 retained by UE1 matches the acquired location registration information Area 2, and thus UE1 determines that the location registration is unnecessary.

When the user equipment 200 is managed by the 5G core network 302, the location registration necessity determination unit 230 determines whether the location registration information of the 5G core network 302 retained by the location registration information management unit 220 matches the location registration information of the 5G core network 302 acquired by the location registration information acquisition unit 210. When the retained location registration information does not match the acquired location registration information, the location registration necessity determination unit 230 determines that the location registration in the 5G core network 302 is necessary and instructs the location registration processing unit 240 to perform the location registration in the 5G core network 302. Conversely, when the retained location registration information matches the acquired location registration information, the location registration necessity determination unit 230 determines that the location registration in the 5G core network 302 is unnecessary.

In the specific example illustrated in FIG. 8, when UE2 is managed by the 5G core network 302 and UE2 moves from the leftmost 5G cell to the middle 5G cell, the location registration information Area A retained by UE2 matches the acquired location registration information Area A, and thus UE2 determines that the location registration is unnecessary. Conversely, when UE2 moves from the middle 5G cell to the rightmost 5G cell, the location registration information Area A retained by UE2 does not match the acquired location registration information Area B, and thus UE2 determines that the location registration in the 5G core network 302 of Area B is necessary.

When it is determined that the location registration in the LTE core network 301 or the 5G core network 302 is necessary, the location registration processing unit 240 performs the location registration in the LTE core network 301 or the 5G core network 302. Specifically, when the location registration necessity determination unit 230 instructs the location registration processing unit 240 to perform the location registration in the LTE core network 301 or the 5G core network 302, the location registration processing unit 240 performs the location registration in the LTE core network 301 or the 5G core network 302. When the location registration succeeds, the location registration information of the LTE core network 301 or the 5G core network 302 is retained by the location registration information management unit 220.

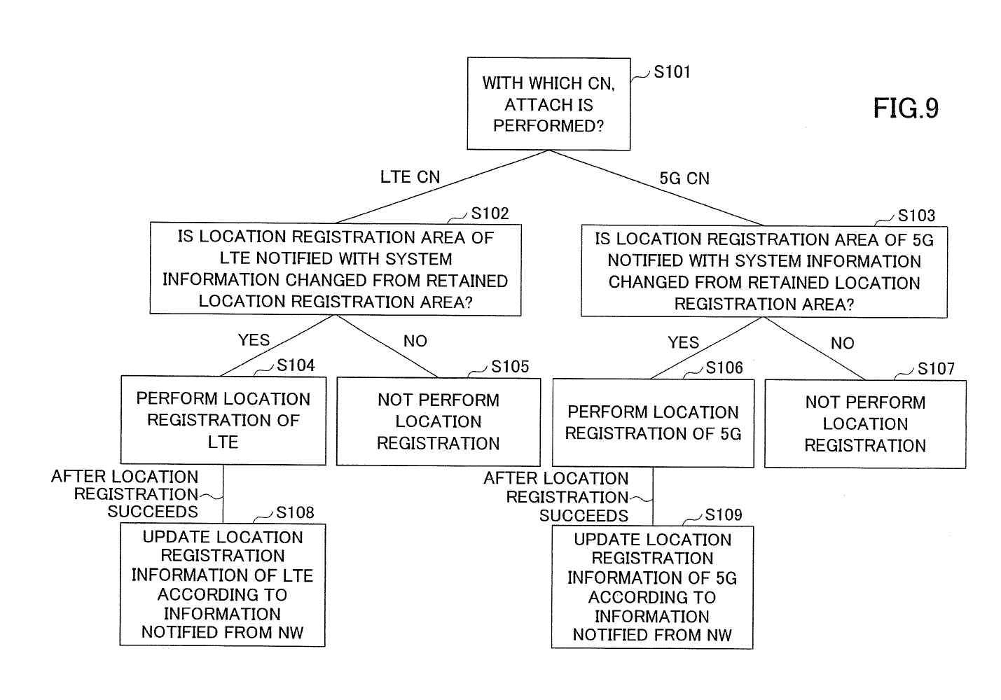

Next, a location registration process by the user equipment according to an embodiment of the invention is described with reference to FIG. 9. FIG. 9 is a flowchart illustrating the location registration process by the user equipment according to the embodiment of the invention.

As illustrated in FIG. 9, in step S101, the location registration necessity determination unit 230 specifies the core network to which the user equipment is attached.

When the specified core network is the LTE core network 301 (S101: LTE CN), in step S102, the location registration necessity determination unit 230 compares the retained location registration information of the LTE core network 301 to the location registration information of the LTE core network 301 acquired from the base station 100 and determines whether there is a change.

When the retained location registration information of the LTE core network 301 does not match the location registration information of the LTE core network 301 acquired from the base station 100 (Yes in S102), the location registration processing unit 240 performs the location registration of the acquired location registration information in the LTE core network 301 in step S104. After the location registration succeeds, the location registration information notified from the LTE core network 301 is stored in the location registration information management unit 220 in step S108. Conversely, when the retained location registration information of the LTE core network 301 does not match the location registration information of the LTE core network 301 acquired from the base station 100 (No in S102), the location registration necessity determination unit 230 determines in step S105 that the location registration is unnecessary.

Conversely, when the specified core network is the 5G core network 302 (S101: 5G CN), the location registration necessity determination unit 230 compares the retained location registration information of the 5G core network 302 to the location registration information of the 5G core network 302 acquired from the base station 100 and determines in step S103 whether there is a change.

When the retained location registration information of the 5G core network 302 does not match the location registration information of the 5G core network 302 acquired from the base station 100 (Yes in S103), the location registration processing unit 240 performs the location registration of the acquired location registration information in the 5G core network 302 in step S106. After the location registration succeeds, the location registration information notified from the 5G core network 302 is stored in the location registration information management unit 220 in step S109. Conversely, when the retained location registration information of the 5G core network 302 does not match the location registration information of the 5G core network 302 acquired from the base station 100 (No in S103), the location registration necessity determination unit 230 determines in step S107 that the location registration is unnecessary.

According to the above-described embodiment, the user equipment 200 can implement the location registration in the LTE core network 301 or the 5G core network 302 of a connection destination at an appropriate timing in the environment in which the LTE core network 301 and the 5G core network 302 coexist.

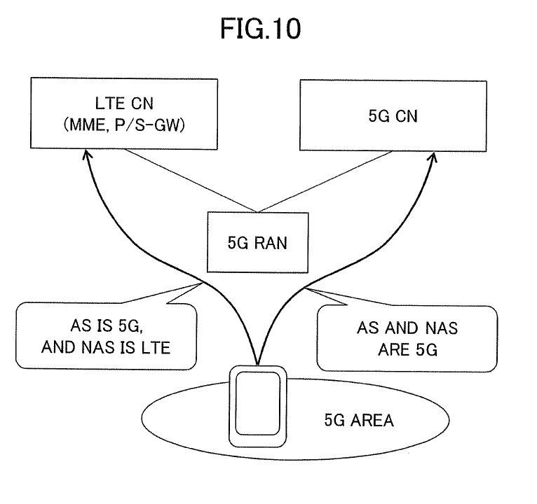

Next a 5G architecture according to another embodiment of the invention is described with reference to FIGS. 10 to 12. FIG. 10 is a schematic diagram illustrating another 5G architecture example.

As illustrated in FIG. 10, the user equipment 200 may be managed by both the LTE core network 301 and the 5G core network 302. That is, in the above-described embodiment, the user equipment 200 is managed by any one of the LTE core network 301 and the 5G core network 302, but the invention is not limited thereto. As illustrated in FIG. 10, the user equipment 200 may be managed by both of the LTE core network 301 and the 5G core network 302. In an embodiment, the user equipment 200 may be managed by the LTE core network 301 or the 5G core network 302 according to a type of bearer. For example, in voice communication using IMS, the user equipment 200 may be managed by the LTE core network 301. In data communication, the user equipment 200 may be managed by the 5G core network 302.

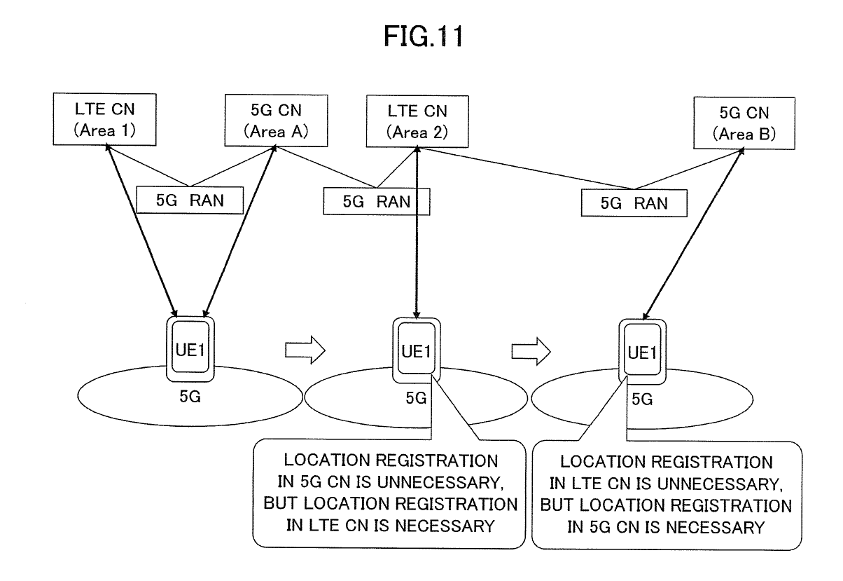

In a 5G architecture illustrated in FIG. 11, when the user equipment 200 residing in the leftmost 5G cell moves to the middle 5G cell, the location registration area of the LTE core network 301 is changed from Area 1 to Area 2. Therefore, when the location registration in the LTE core network 301 of Area 2, the user equipment 200 may not perform communication via the LTE core network 301. Similarly, when the user equipment 200 residing the middle 5G cell moves to the rightmost 5G cell, the location registration area of the 5G core network 302 is changed from Area A to Area B. Therefore, when the location registration in the 5G core network 302 is not performed, the user equipment 200 may not perform communication via the 5G core network 302.

To resolve such a problem, as in the above-described embodiment, the base station 100 notifies the user equipment 200 of location registration information of the LTE core network 301 and location registration information of the 5G core network 302. That is, even in the embodiment, the user equipment 200 is notified of both the location registration information of the LTE core network 301 and the location registration information of the 5G core network 302.

In this case, the location registration information management unit 220 may retain the location registration information of the LTE core network 301 and the location registration information of the 5G core network 302. The location registration necessity determination unit 230 may determine whether the location registration in the LTE core network 301 is necessary by determining whether the retained location registration information of the LTE core network 301 matches the location registration information of the LTE core network 301 acquired from the base station 100 and may determine whether the location registration in the 5G core network 302 is necessary by determining whether the retained location registration information of the 5G core network 302 matches the location registration information of the 5G core network 302 acquired from the base station 100.

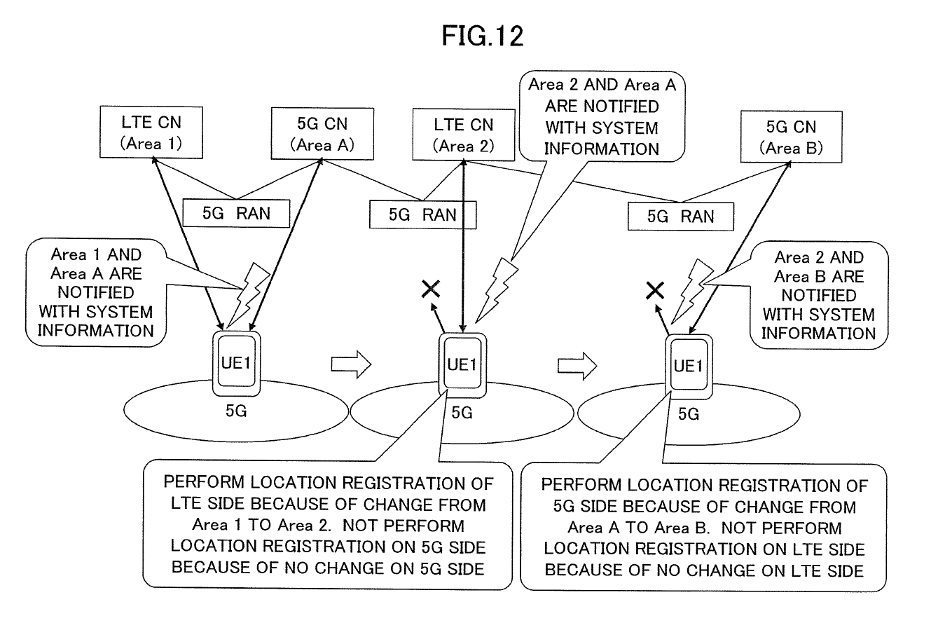

In a specific example illustrated in FIG. 12, UE1 receives system information including the location registration information of the LTE core network 301 and the 5G core network 302 from the base station 100 in a 5G cell in which UE1 resides. For example, when UE1 resides in the leftmost 5G cell, UE1 receives Area 1 as the location registration information of the LTE core network 301 and receives Area A as the location registration information of the 5G core network 302 from the base station 100. When the location registration in the LTE core network 301 and the 5G core network 302 succeeds, the location registration information management unit 220 retains both of the location registration information Area 1 of the LTE core network 301 and the location registration information Area A of the 5G core network 302.

Thereafter, when UE1 moves to the middle 5G cell, UE1 receives Area 2 as the location registration information of the LTE core network 301 and receives Area A as the location registration information of the 5G core network 302 from the base station 100. The location registration necessity determination unit 230 compares the retained location registration information Area 1 of the LTE core network 301 to the acquired location registration information Area 2 of the LTE core network 301. Since the pieces of location registration information do not match each other, the location registration necessity determination unit 230 determines that the location registration of the location registration information Area 2 in the LTE core network 301 is necessary. On the other hand, the location registration necessity determination unit 230 compares the retained location registration information Area A of the 5G core network 302 to the acquired location registration information Area A of the 5G core network 302 in parallel to the foregoing comparison. Since the pieces of location registration information match each other, the location registration necessity determination unit 230 determines that the location registration is unnecessary.

Further, thereafter, when UE1 moves to the rightmost 5G cell, UE1 receives Area 2 as the location registration information of the LTE core network 301 and receives Area B as the location registration information of the 5G core network 302 from the base station 100. The location registration necessity determination unit 230 compares the retained location registration information Area 2 of the LTE core network 301 to the acquired location registration information Area 2 of the LTE core network 301. Since the pieces of location registration information match each other, the location registration necessity determination unit 230 determines that the location registration is unnecessary. On the other hand, the location registration necessity determination unit 230 compares the retained location registration information Area A of the 5G core network 302 to the acquired location registration information Area B of the 5G core network 302 in parallel to the foregoing comparison. Since the pieces of location registration information do not match each other, the location registration necessity determination unit 230 determines that the location registration of the location registration information Area B in the 5G core network 302 is necessary.

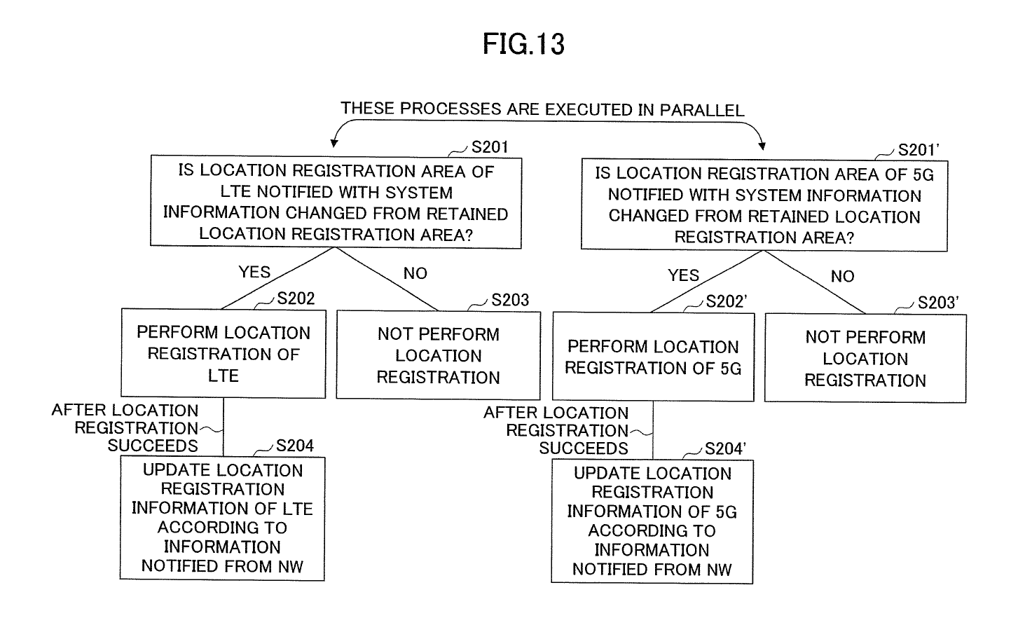

Next, a location registration process by the user equipment according to another embodiment of the invention is described with reference to FIG. 13. FIG. 13 is a flowchart illustrating the location registration process by the user equipment according to an embodiment of the invention.

As illustrated in FIG. 13, steps S201 to S204 are a location registration process for the LTE core network 301 and steps S201′ to S204′ are a location registration process for the 5G network 302. The two location registration processes may be performed in parallel.

In the location registration process for the LTE core network 301, in step S201, the location registration necessity determination unit 230 compares the retained location registration information of the LTE core network 301 to the location registration information of the LTE core network 301 acquired from the base station 100 and determines whether there is a change.

When the retained location registration information of the LTE core network 301 does not match the location registration information of the LTE core network 301 acquired from the base station 100 (Yes in S201), the location registration processing unit 240 performs the location registration of the acquired location registration information in the LTE core network 301 in step S202. After the location registration succeeds, the location registration information notified from the LTE core network 301 is stored in the location registration information management unit 220. Conversely, when the retained location registration information of the LTE core network 301 does not match the location registration information of the LTE core network 301 acquired from the base station 100 (No in S201), the location registration necessity determination unit 230 determines in step S203 that the location registration is unnecessary.

On the other hand, in the location registration process for the 5G core network 302, in step S201′, the location registration necessity determination unit 230 compares the retained location registration information of the 5G core network 302 to the location registration information of the 5G core network 302 acquired from the base station 100 and determines in step S103 whether there is a change.

When the retained location registration information of the 5G core network 302 does not match the location registration information of the 5G core network 302 acquired from the base station 100 (Yes in S201′), the location registration processing unit 240 performs the location registration of the acquired location registration information in the 5G core network 301 in step S202′. After the location registration succeeds, the location registration information notified from the 5G core network 302 is stored in the location registration information management unit 220 in step S204′. Conversely, when the retained location registration information of the 5G core network 302 does not match the location registration information of the 5G core network 302 acquired from the base station 100 (No in S201′), the location registration necessity determination unit 230 determines in step S203′ that the location registration is unnecessary.

According to the above-described embodiment, the user equipment 200 can implement the location registration in the LTE core network 301 and the 5G core network 302 at an appropriate timing in the environment in which both the LTE core network 301 and the 5G core network 302 coexist.

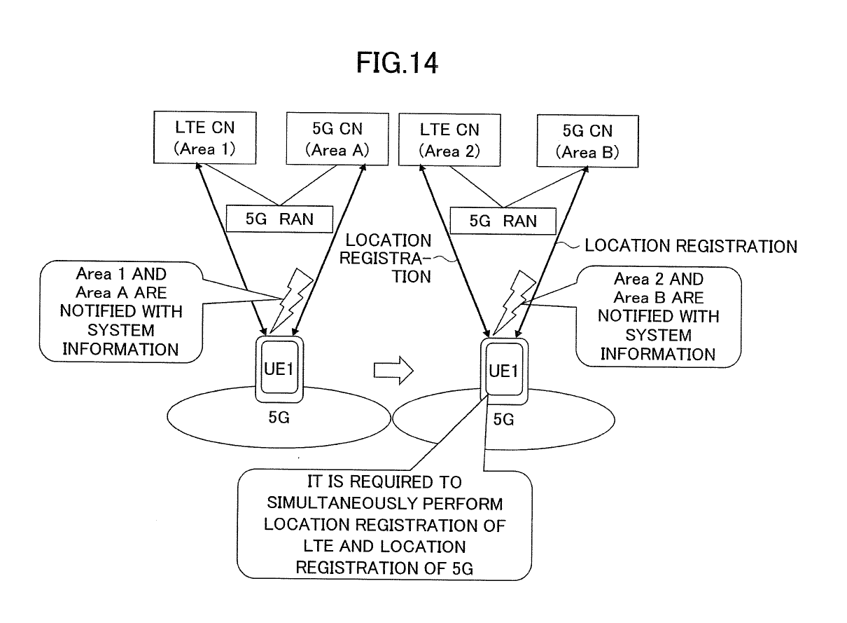

In the embodiment described above with reference to FIGS. 10 to 13, when the location registration necessity determination unit 230 determines that the location registration in both the LTE core network 301 and the 5G core network 302 is necessary, as illustrated in FIG. 14, it is necessary for the location registration processing unit 240 to perform the location registration in both the LTE core network 301 and the 5G core network 302. At this time, it is assumed that radio resources are consumed twice than when the location registration in only one of the LTE core network 301 and the 5G core network 302 is performed, and a load related to the user equipment 200 increases.

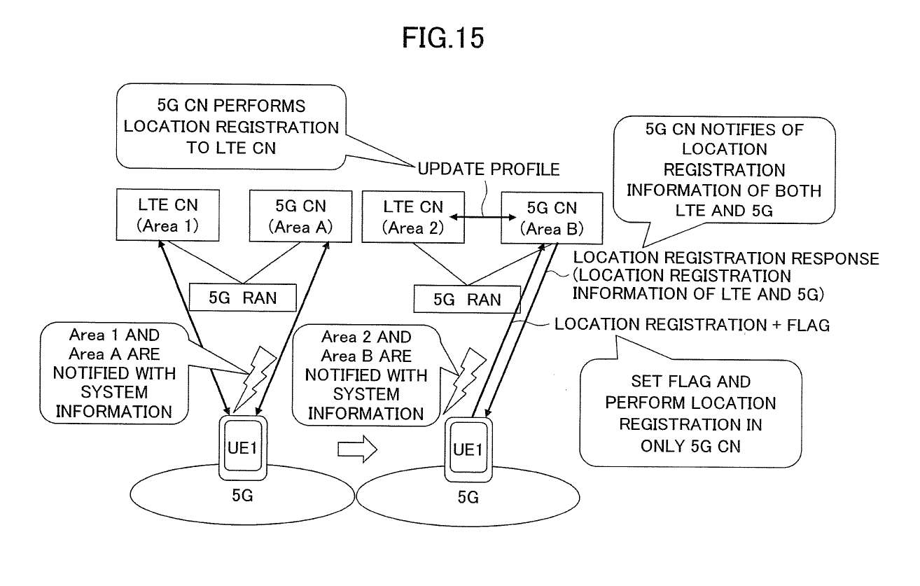

To resolve such a problem, in an embodiment, as illustrated in FIG. 15, when it is determined that the location registration in both the LTE core network 301 and the 5G core network 302 is necessary, the location registration processing unit 240 may also perform the location registration by including a flag indicating that it is necessary to update the location registration in the other core network with respect to one of the LTE core network 301 and the 5G core network 302. When the flag is received, the one core network may instruct the other core network to update the location registration information of the user equipment 200. In the illustrated specific example, UE1 performs the location registration in the 5G core network 302 by including the flag indicating that it is necessary to update the location registration in the LTE core network 301, but the invention is not limited thereto. UE1 may perform the location registration in the LTE core network 301 by including a flag indicating that it is necessary to update the location registration in the 5G core network 302.

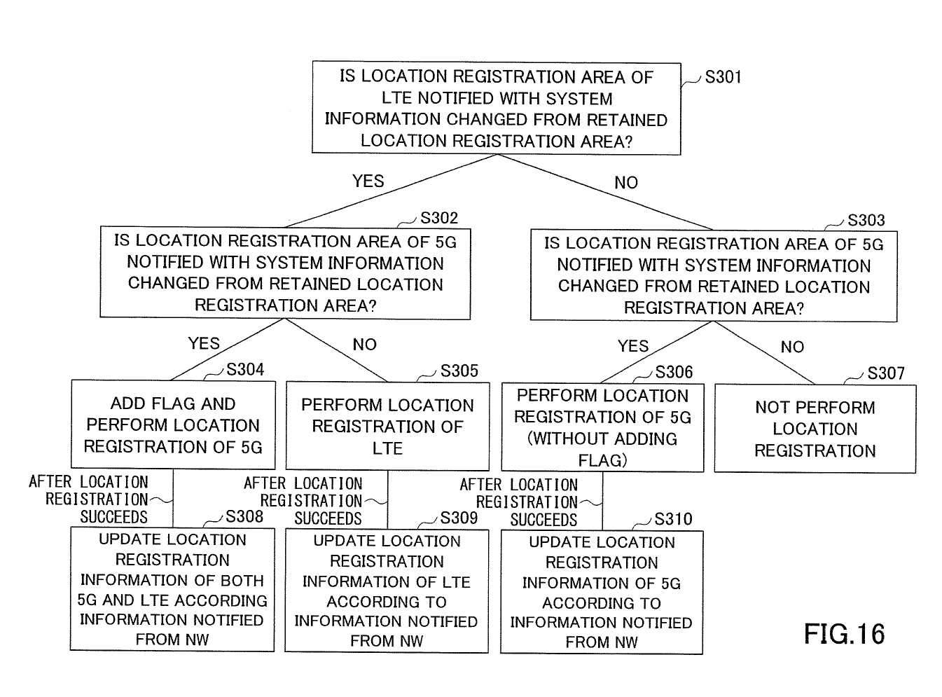

Next, a location registration process by a user equipment according to another embodiment of the invention is described with reference to FIG. 16. FIG. 16 is a flowchart illustrating the location registration process by the user equipment according to the embodiment of the invention.

As illustrated in FIG. 16, in step S301, the location registration necessity determination unit 230 compares the retained location registration information of the LTE core network 301 to the location registration information of the LTE core network 301 acquired from the base station 100 and determines whether there is a change.

When the retained location registration information of the LTE core network 301 does not match the location registration information of the LTE core network 301 acquired from the base station 100 (Yes in S301), in step S302, the location registration necessity determination unit 230 compares the retained location registration information of the 5G core network 302 to the location registration information of the 5G core network 302 acquired from the base station 100 and determines whether there is a change.

When the retained location registration information of the 5G core network 302 does not match the location registration information of the 5G core network 302 acquired from the base station 100 (Yes in S302), the location registration necessity determination unit 230 determines that the location registration in both the LTE core network 301 and the 5G core network 302 is necessary and instructs the location registration processing unit 240 to perform the location registration in both the LTE core network 301 and the 5G core network 302.

In step S304, the location registration processing unit 240 performs the location registration in the 5G core network 302 by including a flag indicating that it is necessary to update the location registration in the LTE core network 301. After the location registration in both the LTE core network 301 and the 5G core network 302 succeeds, the location registration processing unit 240 stores the location registration information of both the LTE core network 301 and the 5G core network 302 in the location registration information management unit 220 in step S308.

Conversely, when the retained location registration information of the 5G core network 302 matches the location registration information of the 5G core network 302 acquired from the base station 100 (No in S302), the location registration necessity determination unit 230 determines that the location registration in only the LTE core network 301 is necessary and instructs the location registration processing unit 240 to perform the location registration in the LTE core network 301. In step S305, the location registration processing unit 240 performs the location registration in the LTE core network 301. After the location registration succeeds, the location registration processing unit 240 updates only the location registration information of the LTE core network 301 in the location registration information management unit 220 in step S309.

Conversely, when the retained location registration information of the LTE core network 301 matches the location registration information of the LTE core network 301 acquired from the base station 100 (No in S301), in step S306, the location registration necessity determination unit 230 compares the retained location registration information of the 5G core network 302 to the location registration information of the 5G core network 302 acquired from the base station 100 and determines whether there is a change.

When the retained location registration information of the 5G core network 302 does not match the location registration information of the 5G core network 302 acquired from the base station 100 (Yes in S303), the location registration necessity determination unit 230 determines that the location registration in only the 5G core network 302 is necessary and instructs the location registration processing unit 240 to perform the location registration in the 5G core network 302.

In step S306, the location registration processing unit 240 performs the location registration in the 5G core network 302. After the location registration succeeds, only the location registration information of the 5G core network 302 is updated in the location registration information management unit 220 in step S310.

Conversely, when the retained location registration information of the 5G core network 302 matches the location registration information of the 5G core network 302 acquired from the base station 100 (No in S303), the location registration necessity determination unit 230 determines that the location registration in either of the LTE core network 301 or the 5G core network 302 is unnecessary.

In the illustrated flowchart, the user equipment 200 performs the location registration in the 5G core network 302 by including the flag indicating that it is necessary to update the location registration in the LTE core network 301, but the invention is not limited thereto. The user equipment 200 may perform the location registration in the LTE core network 301 by including a flag indicating that it is necessary to update the location registration in the 5G core network 302.

In the foregoing embodiment, whether the location registration area of the LTE side is changed is first confirmed and whether the location registration area of the 5G side is changed is subsequently confirmed. However, whether the location registration area of the 5G is changed may be first confirmed and whether the location registration area of the LTE is changed may be subsequently confirmed. Alternatively, whether the location registration area of the LTE side is changed and whether the location registration area of the 5G side is changed may be confirmed in parallel. Then, when the location registration areas of both the sides are changed, a flag may be set.

In the foregoing embodiment, when it is necessary to perform the location registration in both the LTE core network 301 and the 5G core network 302 in the environment in which the LTE core network 301 and the 5G core network 302 coexist, the user equipment 200 can implement the location registration in the other core network by performing the location registration in only one of the core networks.

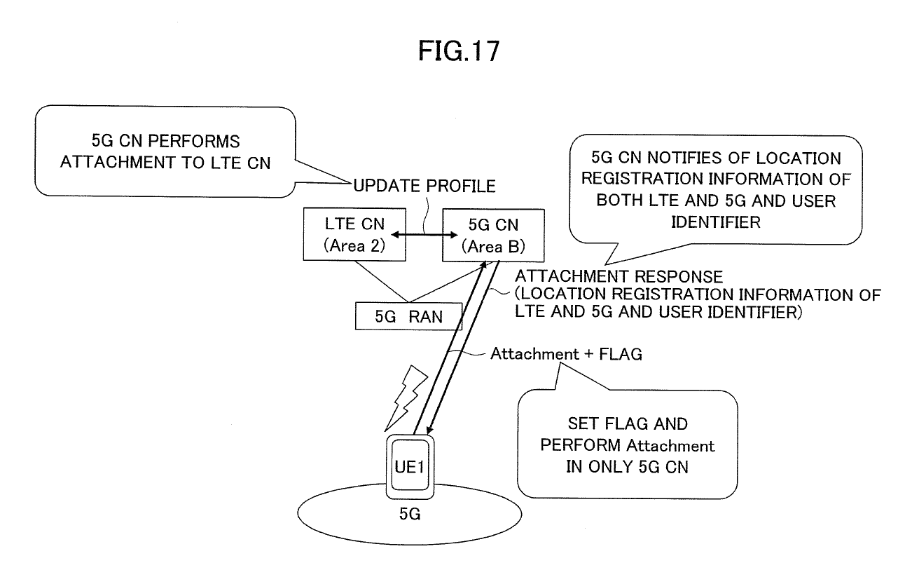

The embodiment in which the above-described flag is used may be typically implemented not only at the time of handover between the base stations 100 performed with movement of the user equipment 200 but also at the time of attachment performed after the user equipment 200 is turned on, as illustrated in FIG. 17. That is, when the user equipment 200 is managed by both the LTE core network 301 and the 5G core network 302, it is necessary for the user equipment 200 to perform the location registration in both the LTE core network 301 and the 5G core network 302 after the user equipment 200 is turned on. To reduce loads and radio resource consumption necessary for the location registration in both the LTE core network 301 and the 5G core network 302, the location registration processing unit 240 may perform location registration including a flag indicating that it is necessary to update the location registration in the other core network with respect to one of the LTE core network 301 and the 5G core network 302 at the time of attachment to both the LTE core network 301 and the 5G core network 302. When the flag is received, the one core network may instruct the other core network to update the location registration information of the user equipment 200. After the location registration in both the LTE core network 301 and the 5G core network 302 succeeds, the one core network may notify of the location registration information of both the LTE core network 301 and the 5G core network 302 along a user identifier.

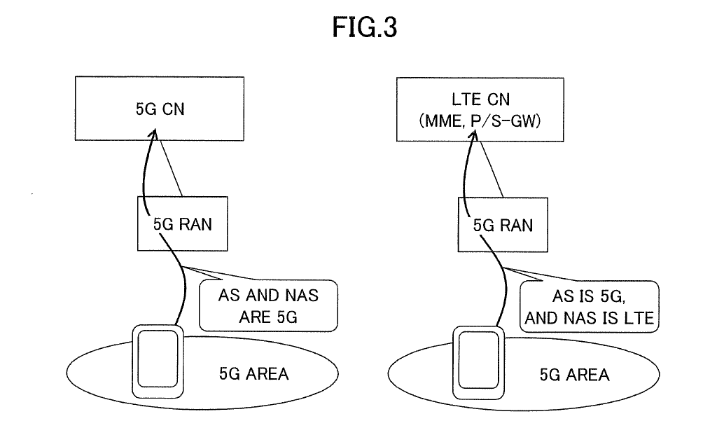

At present, discussion of 5G architectures has started in Third Generation Partnership Project (3GPP). As a 5G architecture, for example, the architecture illustrated in FIG. 3 has been proposed. That is, the left architecture of FIG. 3, the base station and both the core networks conform to the 5G standard. That is, the user equipment interchanges signals with the 5G RAN base station according to the AS protocol in conformity to a 5G standard and interchanges signals with the 5G CN according to the NAS protocol in conformity to a 5G standard.

On the other hand, in the right architecture of FIG. 3, the base station conforms to a 5G standard and the core network conforms to an LTE standard. Since this suppresses development cost, the core network utilizes the LTE standard and is considered as a gradual architecture until complete transitions to the 5G standard. In practice, from the viewpoint of promoting high speed and large capacity of a wireless part, some sufficient advantages can be expected to be achieved by causing only the RAN to the 5G.

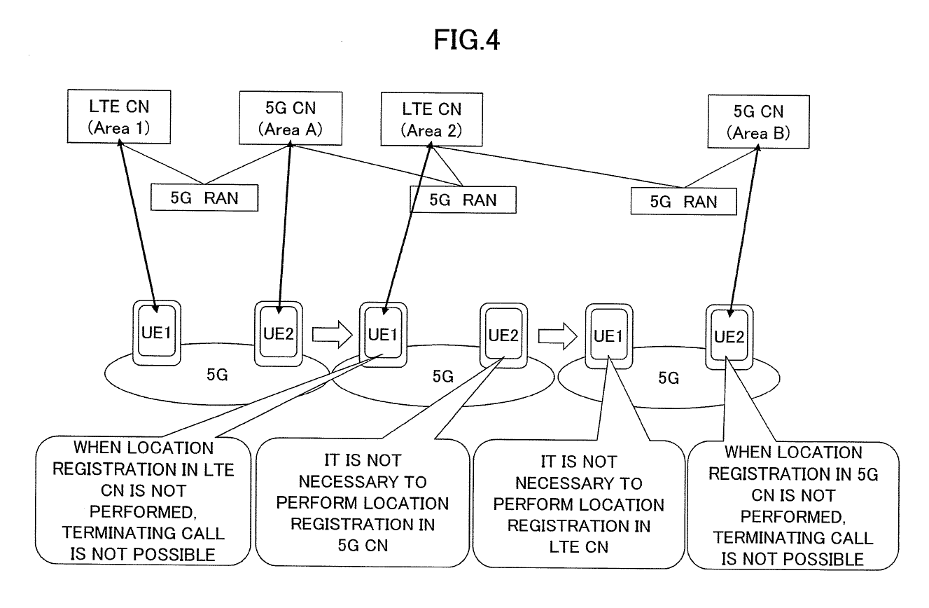

Accordingly, in the transition to the 5G standard, the above-described two types of architectures are assumed to coexist. In an environment in which such different architectures coexist, an execution timing of location registration by a user equipment is considered to be different depending on a core network of a connection destination. Specifically, as illustrated in FIG. 4, it is assumed that UE1 is connected to the LTE CN of Area 1 and UE2 is connected to the 5G CN of Area A. Thereafter, it is assumed that UE1 and UE2 move and UE1 is connected to the LTE CN of another Area 2 while UE2 is still connected to the 5G CN of Area A. In this case, it is not necessary for UE2 to perform location registration in the 5G CN of Area A, but it is necessary for UE1 to perform the location registration in the LTE CN of Area 2. Further, it is assumed that UE1 and UE2 move and UE2 is connected to the 5G CN of another Area B while UE1 is still connected to the LTE CN of Area 2. In this case, it is not necessary for UE1 to perform the location registration in the LTE CN of Area 2, but it is necessary for UE2 to perform the location registration in the 5G CN of Area B.

In the foregoing embodiment, however, the user equipment 200 can implement the location registration in the other core network in accordance with the location registration in only one core network when it is necessary to perform the location registration in both the LTE core network 301 and the 5G core network 302 at the time of attachment after the user equipment 200 is turned on in the environment in which the LTE core network 301 and the 5G core network 302 coexist.

In the foregoing embodiment, the description has been made using the architectures including the LTE core network 301 and the 5G core network 302, but the invention is not limited thereto. It should be apparent to those skilled in the art that the embodiment can be applied to architectures including core network using other different RATs.

As described above, the block diagrams used to describe the functional configurations according to the foregoing embodiment illustrate blocks of functional units. The functional blocks (constituent elements) are implemented by any combination of hardware and/or software. In addition, means for realizing each functional block is not particularly limited. That is, each functional block may be implemented by one apparatus in which the functional blocks are combined physically and/or logically or may be implemented by two or more apparatuses that are physically and/or logically separated by connecting the plurality of apparatuses directly and/or indirectly (for example, in a wired and/or wireless manner).

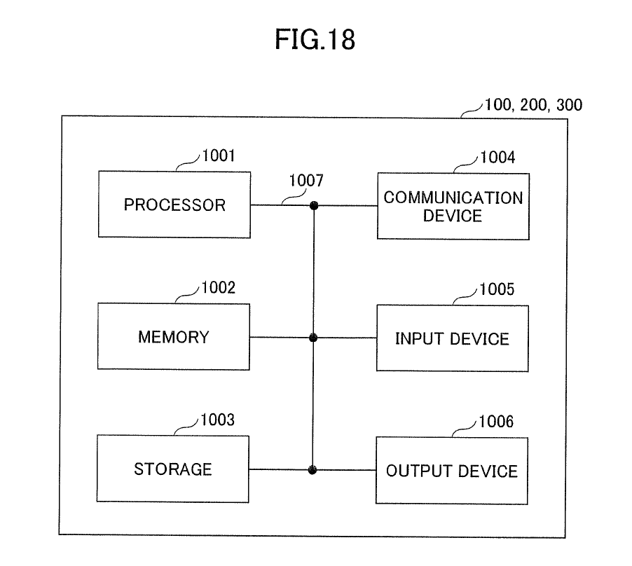

For example, the base station 100, the user equipment 200, and the management apparatus 300 according to an embodiment of the invention may function as a computer that performing a process for a radio communication method according to the invention. FIG. 18 is a block diagram illustrating a hardware configuration of the base station 100, the user equipment 200, and the management apparatus 300 according to an embodiment of the invention. The above-described transmitter 100 and receiver 200 may be physically configured as a computer apparatus that includes a processor 1001, a memory 1002, a storage 1003, a communication apparatus 1004, an input apparatus 1005, an output apparatus 1006, and a bus 107.

In the following description, a term “apparatus” can be replaced with a circuit, a device, a unit, or the like. The hardware configuration of the base station 100, the user equipment 200, and the management apparatus 300 may be configured to one apparatus or a plurality of apparatuses illustrated in the drawing or may be configured not to include some of the apparatuses.

The functions of the base station 100, the user equipment 200, and the management apparatus 300 are implemented by reading predetermined software (program) on hardware such as the processor 1001 or the memory 1002 so that the processor 1001 can perform an arithmetic operation and controlling communication by the communication apparatus 1004 and reading and/or writing of data in the memory 1002 and the storage 1003.

For example, the processor 1001 controls the entire computer by operating an operating system. The processor 1001 may also be configured as a central processing unit (CPU) that includes an interface with a peripheral apparatus, a control apparatus, an arithmetic apparatus, and a register. For example, each of the above-described components may be implemented by the processor 1001.

The processor 1001 reads a program (program codes), a software module, or data from the storage 1003 and/or the communication apparatus 1004 to the memory 1002 and performs various processes according to the program, the software module, or the data. As the program, a program causing a computer to perform at least some of the operations described in each of the foregoing embodiment is used. For example, the processes by the communication control unit 110, the location registration information transmission unit 120, the location registration information acquisition unit 210, the location registration information management unit 220, the location registration necessity determination unit 230, and the location registration processing unit 240 described above may be implemented by a control program that is stored in the memory 1002 and is operated by the processor 1001 or may be implemented similarly in another functional block. The above-described various processes performed by one processor 1001 have been described, but may be performed simultaneously or sequentially by two or more processors 1001. The processor 1001 may be mounted on one or more chips. The program may be transmitted from a network via an electric communication circuit.

The memory 1002 is a computer-readable recording medium and may be configured by at least one of, for example, a read-only memory (ROM), an erasable programmable ROM (EPROM), an electrically erasable programmable ROM (EEPROM), and a random access memory (RAM). The memory 1002 may also be referred to as a register, a cache, a main memory (main storage apparatus), or the like. The memory 1002 can store a program (program codes), a software module, or the like which can be executed to perform a radio communication method according to each embodiment of the invention.

The storage 1003 is a computer-readable recording medium and may be configured by at least one of, for example, an optical disc such as a compact disc ROM (CD-ROM), a hard disk drive, a flexible disc, a magneto-optical disc (for example, a compact disc, a digital versatile disk, a Blu-ray (registered trademark) disc), a smart card, a flash memory (for example, a card, a stick, or a key drive), a floppy (registered trademark) disk, and a magnetic script. The storage 1003 may also be referred to as an auxiliary storage apparatus. The above-described storage medium may be, for example, a database or a server including the memory 1002 and/or the storage 1003 or another appropriate medium.

The communication apparatus 1004 is hardware (a transmission and reception device) that performs communication between computers via a wired and/or wireless network and is also referred to as, for example, a network device, a network controller, a network card, or a communication module. For example, the communication control unit 110, the location registration information transmission unit 120, the location registration information acquisition unit 210, the location registration information management unit 220, the location registration necessity determination unit 230, and the location registration processing unit 240 described above may be implemented by the communication apparatus 1004.

The input apparatus 1005 is an input device (for example, a keyboard, a mouse, a microphone, a switch, a button, or a sensor) that receives an input from the outside. The output apparatus 1006 is an output device (for example, a display, a speaker, or an LED lamp) that performs an output to the outside. The input apparatus 1005 and the output apparatus 1006 may be configured to be integrated (for example, a touch panel).

The apparatuses such as the processor 1001 and the memory 1002 are connected to the bus 1007 communicating information. The bus 1007 may be configured as a single bus or may be configured by different buses between the apparatuses.

The base station 100, the user equipment 200, and the management apparatus 300 may be configured to include hardware such as a microprocessor, a digital signal processor (DSP), an application specific integrated circuit (ASIC), a programmable logic device (PLD), or a field programmable gate array (FPGA), or some or all of the functional blocks may be implemented by the hardware. For example, the processor 1001 may be mounted as at least one of the hardware.

The notification of information is not limited to the aspects/embodiments described in the present specification and may be performed in accordance with other methods. For example, the notification of information may be performed with physical layer signaling (for example, downlink control information (DCI) or uplink control information (UCI)), higher layer signaling (for example, radio resource control (RRC) signaling, medium access control (MAC) signaling, or report information (master information block (MIB), or a system information block (SIB))), another signal, or a combination thereof. The RRC signaling may be referred to as an RRC message or may be referred to as, for example, an RRC connection setup message or an RRC connection reconfiguration message.

Each aspect/embodiment described in the present specification may be applied to a system in which Long Term Evolution (LTE), LTE-Advanced (LTE-A), SUPER 3G, IMT-Advanced, 4G, 5G, Future Radio Access (FRA), W-CDMA (registered trademark), GSM (registered trademark), CDMA2000, Ultra Mobile Broadband (UMB), IEEE 802.11 (Wi-Fi), IEEE 802.16 (WiMAX), IEEE 802.20, Ultra-WideBand (UWB), Bluetooth (registered trademark), and other appropriate systems are used and/or a next generation system extended based on the system.

The order of the process procedure, the sequence, the flowchart, or the like of each aspect/embodiment described in the present specification may be interchanged unless there is contradiction. For example, in the method described in the present specification, elements of various steps have been proposed in exemplary orders and the invention is not limited to the proposed specific orders.

In the present specification, a specific operation performed by the base station 100 and the management apparatus 300 is also performed further by an upper node depending on a case. In a network formed by one network node or a plurality of network nodes including a base station, it should be apparent that various operations performed to communicate with a terminal are considered to be able to be performed by a base station and/or another network node (for example, an MME or an S-GW is considered, but the invention is not limited thereto) other than a base station. The case in which the number of other network nodes other than the base station is 1 has been exemplified above, but a combination of a plurality of other network nodes (for example, an MME and an S-GW) may be used.

Information or the like can be output from a higher layer (or a lower layer) to a lower layer (or a higher layer). Information or the like may be input or output via a plurality of network nodes.

The input or output information or the like may be stored in a specific location (for example, a memory) or may be managed with a management table. Information or the like to be input and output may be overwritten, updated, or edited. Information or the like to be output may be deleted. Information or the like to be input may be transmitted to another apparatus.

Determination may be performed with a value (0 or 1) represented by 1 bit, may be performed by a true or false value (Boolean: true or false), or may be performed through comparison of a numerical value (for example, comparison with a predetermined value).

The aspects/embodiments described in the present specification may be singly used, may be combined, or may be switched and used in accordance with execution. In addition, notification of predetermined information (for example, notification of “being X”) is not limited to being performed explicitly and may be performed implicitly (for example, the notification of the predetermined information is not performed).

The invention has been described in detail above, but it should be apparent to those skilled in the art that the invention is not limited to the embodiments described in the present specification. The invention can be embodied as corrected and changed aspects without departing from the gist and the scope of the invention decided in the description of the claims. Accordingly, the description of the present specification has been made for exemplary description and has no limited meaning to the invention.

Regardless of the fact that software is referred to as software, firmware, middleware, a microcode, or a hardware description language or is referred to as another name, the software is broadly interpreted as meaning a command, a command set, a code, a code segment, a program code, a program, a sub-program, a software module, an application, a software application, a software package, a routine, a subroutine, an object, an executable file, an execution thread, a procedure, a function, or the like.

Software, a command, or the like may be transmitted or received via a transmission medium. For example, when software is transmitted from a website, a server, or another remote source using a wired technology such as a coaxial cable, an optical cable, a twisted pair, and a digital subscriber line (DSL) and/or a wireless technology such as an infrared ray, radio, and microwaves, the wired technology and/or the wireless technology is included in definition of a transmission medium.

The information, the signal, and the like described in the present specification may be represented using any of various other technologies. For example, the data, the order, the command, the information, the signal, the bit, the symbol, the chip, and the like mentioned throughout the foregoing description may be represented by a voltage, a current, an electromagnetic wave, a magnetic field, or a magnetic particle, an optical field or a photon, or any combination thereof.

The terms described in the present specification and/or terms necessary to understand the present specification may be replaced with terms that have same or similar meanings. For example, a channel and/or a symbol may be a signal. A signal may be a message. A component carrier (CC) may be referred to as a carrier frequency, a cell, or the like.

The terms “system” and “network” used in the present specification are compatibly used.

The information, the parameter, or the like described in the present specification may be represented by an absolute value, may be represented by a relative value from a predetermined value, or may be represented by another piece of corresponding information. For example, a radio resource may be instructed with an index.

The names used for the above-described parameters are not limited in any respect. Further, a numerical expression or the like in which the parameters are used can be different from a numerical expression disclosed explicitly in the present specification. Since various channels (for example, PUCCH and PDCCH) and information elements (for example, TPC) can all be identified with appropriate names, various names allocated to the various channels and information elements are not limited in any respect.

A base station can accommodate one cell (also referred to as a sector) or a plurality (for example, three) of cells. When a base station accommodates a plurality of cells, the entire coverage area of the base station can be divided in to a plurality of smaller areas and each of the smaller areas can also provide a communication service using a base station subsystem (for example, an indoor small-sized base station remote radio head (RRH)). The term “cell” or “sector” refers to a part or all of a coverage area of a base station and/or a base station subsystem that performs a communication service in the coverage. Further, the terms, a “base station,” an “eNB,” a “cell,” and a “sector” can be compatibly used in the present specification. A base station can also be referred to as the term such as a fixed station, NodeB, eNodeB (eNB), an access point, a femtocell, or a small cell.

A mobile station is referred to as a subscriber station, a mobile unit, a subscriber unit, a radio unit, a remote unit, a mobile device, a radio device, a radio communication device, a remote device, a mobile subscriber station, an access terminal, a mobile terminal, a radio terminal, a remote terminal, a handset, a user agency, a mobile client, a client, or several other appropriate terms by those skilled in the art.

The term “determining” used in the present specification include a wide variety of operations in some cases. The “determining” can include cases in which performing, for example, calculating, computing, processing, deriving, investigating, looking up (for example, looking up in a table, a database, or another data structure), and ascertaining is considered to perform “determining.” In addition, the “determining” can include cases in which performing, for example, receiving (for example, receiving information), transmitting (for example, transmitting information), inputting, outputting, and accessing (for example, accessing data in a memory) is considered to perform “determining”. In addition, the “determining” can include cases in which performing, for example, resolving, selecting, choosing, establishing, and comparing is considered to be perform “determining.” That is, the “determining” can include a case in which any operation is considered to perform “determining.”

The term “connected” or “coupled” or all modifications of the term means all direct or indirect connection or coupling between two or more elements and can include presence of one or more intermediate elements between two mutually “connected” or “coupled” elements. The connection or the coupling between elements may be physical connection, logical connection, or any combination thereof. When the connection or the coupling is used in the present specification, two elements can be considered to be mutually “connected” or “coupled” by using one or more electric wires, cables, and/or printed electric connection and using electromagnetic energy such as electromagnetic energy with a wavelength of a radio frequency region, a microwave region, and a light (both visible light and invisible light) region as several non-limited and non-inclusive examples.

A reference signal can also be abbreviated to RS (reference signal) and may also be referred to as a pilot in accordance with a standard to be applied.

The description “based on” used in the present specification does not imply “based on only” as long as otherwise mentioned. In other words, the description of “based on” implies both of “based on only” and “based on at least.”

When reference to elements in which names “first,” “second,” and the like used in the present specification are used is made, the amount or order of the elements is not limited generally either. The names can be used in the present specification as methods used to conveniently distinguish two or more elements from each other. Accordingly, reference to first and second elements does not imply that only two elements are employed or a first element is prior to a second element in a certain form.

“Means” in the configuration of each of the foregoing apparatuses may be replaced with a “unit,” a “circuit,” or a “device.”

The terms “including” and “comprising” are intended to be general as in the term “providing” as long as “including,” “comprising,” and modifications thereof are used in the present specification or the claims. Further, the term “or” used in the present specification or the claims is intended not to be exclusive OR.

A radio frame may be configured to include one frame or a plurality of frames in a time domain. One frame or each of a plurality of frames in the time domain may also be referred to as a subframe in the time domain. A subframe may also be further configured to include one slot or a plurality of slots in the time domain. A slot may also be further configured to include one symbol or a plurality of symbols (OFDM symbols, SC-FDMA symbols, or the like) in the time domain. The radio frame, the subframe, the slot, and the symbol all represent time units when a signal is transmitted. The radio frame, the subframe, the slot, and the symbol may be respectively corresponding calling methods. For example, in an LTE system, a base station performs scheduling to allocate radio resources (frequency bandwidths, transmission power, or the like which can be used by mobile stations) to mobile stations. A minimum time unit of the scheduling may also be referred to as a transmission time interval (TTI). For example, one subframe may also be referred to as a TTI, a plurality of consecutive subframes may also be referred to as a TTI, or one slot may also be referred to as a TTI. A resource block (RB) is a resource allocation unit of a time domain and a frequency domain and may also include one subcarrier or a plurality of consecutive subcarriers in the frequency domain. The resource block may include one symbol or a plurality of symbols in the time domain of the resource block or may also be the length of one slot, one subframe, or one TTI. One TTI or one subframe may each be configured to include one resource block or a plurality of resource blocks. The structure of the above-described radio frame is merely an example. The number of subframes included in the radio frame, the number of slots included in the subframe, the number of symbols and resource blocks included in the slot, and the number of subcarriers included in the resource block can be modified variously.

The embodiments of the invention are described in detail above, but the invention is not limited to the above-described specific embodiments and can be modified and changed in various forms within the scope of the gist of the invention described in the claims.

This patent application is based on and claims priority to Japanese Patent Application No. 2016-136421 filed on Jul. 8, 2016, and the entire contents of Japanese Patent Application No. 2016-136421 are incorporated herein by reference.

### LIST OF REFERENCE SYMBOLS

10 radio communication system
100 base station
110 communication control unit
120 location registration information transmission unit
200 user equipment
210 location registration information acquisition unit
220 location registration information management unit
230 location registration necessity determination unit
240 location registration processing unit
301 LTE core network
302 5G core network

1. A radio communication system comprising:
a user equipment;
a base station configured to perform radio communication with the user equipment;
a first management apparatus configured to be communicatively connected to the base station and manage the user equipment according to a first radio access technology (RAT); and
a second management apparatus configured to be communicatively connected to the base station and manage the user equipment according to a second RAT different from the first RAT,
wherein the base station includes
a communication control unit that controls radio communication with the user equipment, and
a location registration information transmission unit that transmits first location registration information of the first management apparatus and second location registration information of the second management apparatus, and
wherein the user equipment includes
a location registration information acquisition unit that acquires the first location registration information and the second location registration information from the base station,
a location registration information management unit that retains location registration information,
a location registration necessity determination unit that determines that location registration in the first or second management apparatus is necessary based on the retained location registration information and the location registration information corresponding to the management apparatus managing the user equipment between the acquired first location registration information and second location registration information, and
a location registration processing unit that performs location registration in the first or second management apparatus when it is determined that the location registration in the first or second management apparatus is necessary.

2. The radio communication system according to claim 1,
wherein when the management apparatus managing the user equipment is the first management apparatus, the location registration necessity determination unit determines whether the location registration in the first management apparatus is necessary by determining whether the retained location registration information matches the acquired first location registration information, and
when the management apparatus managing the user equipment is the second management apparatus, the location registration necessity determination unit determines whether the location registration in the second management apparatus is necessary by determining whether the retained location registration information matches the acquired second location registration information.

3. The radio communication system according to claim 1,
wherein the user equipment is managed by both the first and second management apparatuses,
wherein the location registration information management unit retains the first location registration information and the second location registration information, and
wherein the location registration necessity determination unit determines whether the location registration in the first management apparatus is necessary by determining whether the retained first location registration information matches the acquired first location registration information, and determines whether the location registration in the second management apparatus is necessary by determining whether the retained second location registration information matches the acquired second location registration information.

4. The radio communication system according to claim 3,
wherein when it is determined that the location registration in both the first and second management apparatuses is necessary, the location registration processing unit performs location registration by including a flag indicating that it is necessary to update the location registration in the other management apparatus with respect to one of the first and second management apparatuses.

5. The radio communication system according to claim 3,
wherein when attachment to both the first and second management apparatuses is formed, the location registration processing unit performs location registration including a flag indicating that it is necessary to update the location registration in the other management apparatus with respect to one of the first and second management apparatuses.

6. The radio communication system according to claim 4,
wherein the flag is received, the one management apparatus instructs the other management apparatus to update the location registration information of the user equipment.

7. The radio communication system according to claim 4,
wherein when attachment to both the first and second management apparatuses is formed, the location registration processing unit performs location registration including a flag indicating that it is necessary to update the location registration in the other management apparatus with respect to one of the first and second management apparatuses.

8. The radio communication system according to claim 5,
wherein the flag is received, the one management apparatus instructs the other management apparatus to update the location registration information of the user equipment.

9. The radio communication system according to claim 7,
wherein the flag is received, the one management apparatus instructs the other management apparatus to update the location registration information of the user equipment.
